(19) United States
(12) Patent Application Publication
(10) Pub. No.: US 2026/0142065 A1
(43) Pub. Date: May 21, 2026

(54) PERMANENT MAGNET DEMAGNETIZATION METHOD, DEVICE, AND MAGNET

(71) Applicant: BEIJING ZHONG KE SAN HUAN HI-TECH CO., LTD., Beijing (CN)

(72) Inventors: Fengqiao LIU, Beijing (CN); E NIU, Beijing (CN); Jindong WANG, Beijing (CN); Guoan FU, Beijing (CN); Zhan WANG, Beijing (CN); Xiaolei RAO, Beijing (CN)

(21) Appl. No.: 19/441,604

(22) Filed: Jan. 6, 2026

Related U.S. Application Data
(63) Continuation of application No. PCT/CN2024/120394, filed on Sep. 23, 2024.

(30) Foreign Application Priority Data
Oct. 8, 2023 (CN) 202311286572.6

(51) Int. Cl. H01F 13/00

(52) U.S. Cl. CPC H01F 13/006

(57) ABSTRACT

A demagnetization method, device, and magnet. The demagnetization method includes applying a decaying alternating magnetic field to a permanent magnet, where a direction of the decaying alternating magnetic field forms a predetermined angle with a magnetization direction of the permanent magnet, and the predetermined angle ranges from 45° to 135°.

### CROSS-REFERENCE TO RELATED APPLICATION

This application is a continuation of International Application No. PCT/CN2024/120394, filed on Sep. 23, 2024, which claims priority to Chinese Application No. 202311286572.6, filed on Oct. 8, 2023, the entire contents of both of which are incorporated herein by reference.

### TECHNICAL FIELD

The present disclosure relates to a permanent magnet demagnetization method, device, and magnet.

### BACKGROUND

Permanent magnets, due to their unique properties, have been widely used in various aspects of production and daily life.

In particular, neodymium-iron-boron (NdFeB) permanent magnets are extensively applied in numerous fields such as automobiles, electronics, machinery, energy, and medical devices due to their excellent magnetic performance. NdFeB magnets contain critical rare earth elements, including praseodymium, neodymium, dysprosium, and terbium. With the rapid expansion of the NdFeB market, the demand for these rare earth elements has surged, leading to increased attention on the supply of rare earth elements used in NdFeB magnets. The recovery and reuse of rare earth elements from discarded NdFeB permanent magnets has become a research hotspot in recent years.

Discarded NdFeB permanent magnets originate from two main sources: first, from downstream products such as old electric vehicles or discarded electronic devices like mobile phones and headphones, which contain significant amounts of NdFeB magnets; second, from the manufacturing process of the magnets themselves, where issues such as surface scratches, incorrect magnetization polarity, and weak magnetism can render them unusable. Since the NdFeB magnets needing recovery retain their magnetic properties, the demagnetization process is a necessary step in their recycling.

Conventional demagnetization methods typically include thermal demagnetization and magnetic field demagnetization. Existing thermal demagnetization methods usually involve baking the permanent magnets at high temperatures (requiring temperatures to reach the Curie point of the magnets) for demagnetization. However, this high-temperature approach can easily lead to surface oxidation of the permanent magnets, which increases the risk of magnetic and mechanical damage.

The magnetic field demagnetization method can avoid the issue of surface oxidation and subsequent magnetic damage associated with high-temperature heating in the thermal demagnetization method, allowing for the reuse of recovered permanent magnets. Conventional magnetic field demagnetization methods typically include two approaches: reverse magnetic field demagnetization and decaying alternating magnetic field demagnetization.

Reverse magnetic field demagnetization involves applying a magnetic field that is opposite to the original magnetization direction of the permanent magnet. Precise control of the intensity of the reverse demagnetizing field is needed to ensure that after its removal, the magnetic induction intensity or residual magnetic moment of the permanent magnet becomes zero. However, the specifications of the permanent magnet and its magnetization and demagnetization characteristics can affect the required strength of the reverse demagnetizing field, making it challenging to accurately determine the needed intensity.

FIG. 1 illustrates a schematic of the existing technology that uses a reverse magnetic field for demagnetizing permanent magnets. As shown, the magnetization direction of the permanent magnet is denoted by “c,” and during demagnetization, an external magnetic field Hex is applied. The direction of the magnetic field Hex is parallel and opposite to the magnetization direction c of the permanent magnet. In practical operations, the magnitude of the applied magnetic field Hex must be determined through numerous trials based on the intrinsic coercivity and shape of the permanent magnet. However, even with this approach, the demagnetization effect is often unsatisfactory, and achieving a near-zero residual magnetic moment after the external magnetic field is removed is difficult.

The decaying alternating magnetic field demagnetization method places the permanent magnet in an alternating magnetic field provided by a demagnetization device, utilizing a decreasing hysteresis loop for demagnetization. However, the decay rate and number of decays in conventional demagnetization machines are predetermined, leaving only the initial magnetic field strength adjustable. Determining the initial magnetic field strength for permanent magnets with different magnetization characteristics and specifications is also challenging.

FIG. 2 illustrates a schematic of the existing technology that utilizes a decaying alternating magnetic field for demagnetizing permanent magnets. In this case, the magnetization direction of the permanent magnet is still “c”, and during demagnetization, an external alternating magnetic field Hₑₓ₁ is applied. The direction of the magnetic field Hₑₓ₁ is parallel to the magnetization direction c of the permanent magnet and decays oscillatory in that direction. In practical disclosures, the initial magnitude of the applied decaying alternating magnetic field Hₑₓ₁ must be determined through numerous trials, taking into consideration factors such as the intrinsic coercivity of the permanent magnet, its shape, the frequency of the decaying alternating magnetic field, and the conditions of the amplitude decay. Moreover, similar to the aforementioned reverse magnetic field demagnetization method, the demagnetization effect is often challenging to achieve, as the remaining magnetic moment is difficult to reduce to near zero after the external magnetic field is removed.

In the existing technology, the aforementioned two electromagnetic demagnetization methods typically result in a significant residual magnetic moment remaining in the permanent magnets after demagnetization, even after the external magnetic field is withdrawn. Furthermore, during batch operations, the consistency of the demagnetization results is often poor.

### SUMMARY

Given the problems in existing technologies, the present disclosure provides demagnetization method for permanent magnet, demagnetization device and magnet.

The first aspect of the present disclosure provides a demagnetization method for permanent magnet. The demagnetization method includes applying a decaying alternating magnetic field to the permanent magnet, where the direction of the decaying alternating magnetic field forms a second predetermined angle with the magnetization direction of the permanent magnet, and the second predetermined angle is from 45° to 135°.

The second aspect of the present disclosure provides a magnet that is obtained after treatment by the method described above, wherein the magnitude of the residual magnetic moment of the magnet is less than 5% of the magnitude of the saturated magnetization in the original magnetization direction, and the absolute value of the ratio of the component of the residual magnetic moment perpendicular to the original magnetization direction to the component parallel to the original magnetization direction is greater than) tan (5°.

The third aspect of the present disclosure provides a demagnetization method for a localized region of permanent magnet, comprises:
placing a demagnetization coil near the localized region of the permanent magnet, wherein the demagnetization coil includes an upper coil and a lower coil, with the upper coil positioned above the localized region and the lower coil positioned below the localized region; and
passing a current through the demagnetization coil to generate a demagnetizing field that forms a predetermined angle with the magnetization direction of the localized region, wherein the magnetic field directions produced by the upper coil and the lower coil are the same.

According to the fourth aspect of the present disclosure, a demagnetization device for a localized region of a permanent magnet is provided, which comprises:
an upper coil configured to be positioned above the localized region; and
a lower coil configured to be positioned below the localized region and opposite to the upper coil, wherein the magnetic field directions produced by the upper coil and the lower coil are the same and form a predetermined angle with the magnetization direction of the localized region.

The fifth aspect of the present disclosure provides a magnet obtained after treatment by the method described in the third aspect or by the device described in the fourth aspect, wherein the magnitude of the residual magnetic moment of the localized region of the magnet is less than or equal to 40% Mₘₐₓ, and the magnetic moment magnitude of the region of the magnet outside the localized region is greater than or equal to 90% Mₘₐₓ, where Mₘₐₓ is the saturated magnetic moment of the localized region.

Thus, by applying a first magnetic field that has a parallel and opposite component to the magnetization direction and a decaying alternating magnetic field that has a perpendicular component to the magnetization direction, the demagnetization process can be effectively completed under the combined action of both fields, resulting in a low ratio of the residual magnetic moment after demagnetization to the magnetic moment during saturation magnetization of the magnet.

### BRIEF DESCRIPTION OF THE DRAWING

To provide a clearer understanding of the technical solutions in the embodiments of the present disclosure, a brief introduction to the accompanying drawings that will be used in the description of the embodiments is presented below. It is evident that the accompanying drawings described here are merely some embodiments of the present disclosure. Those skilled in the art can, without any creative effort, derive additional drawings based on these illustrations.

FIG. 1 is a schematic diagram showing utilizing a reverse magnetic field to demagnetize a permanent magnet.

FIG. 2 a schematic diagram showing utilizing an alternating decaying magnetic field to demagnetize a permanent magnet.

FIG. 3 illustrates a flowchart of a method for demagnetizing a permanent magnet according to one embodiment of the disclosure.

FIG. 4A is a schematic diagram showing the magnetic field operation according to the embodiment.

FIG. 4B illustrates a waveform diagram of the decaying alternating magnetic field according to one embodiment of the present disclosure, showing the meanings of parameters f and n.

FIG. 5 illustrates a flowchart of a method for demagnetizing a permanent magnet according to another embodiment of the present disclosure.

FIG. 6 is a schematic diagram showing the magnetic field operation according to the embodiment.

FIG. 7 is a schematic diagram showing the magnetic field operation for in-situ bulk demagnetization of multiple permanent magnets in a component assembly according to one embodiment of the present disclosure.

FIG. 8 illustrates a flowchart of a method for demagnetizing a permanent magnet according to another embodiment of the present disclosure.

FIG. 9 is a schematic diagram showing a Helmholtz coil measuring a sample.

FIG. 10 is a schematic diagram showing magnetic moment measurement and the angle of the magnetic moment.

FIG. 11 is a schematic diagram showing magnetic moment measurements in different directions.

FIG. 12 illustrates a flowchart of a method for demagnetizing a localized region of a permanent magnet according to one embodiment of the present disclosure.

FIG. 13 is a schematic diagram showing the demagnetization operation according to the embodiment.

FIG. 14 is a schematic diagram showing the gap setting between the upper coil and the lower coil according to one embodiment of the present disclosure.

FIG. 15 illustrates a flowchart of a method for demagnetizing a localized region of a permanent magnet according to another embodiment of the present disclosure.

FIG. 16 is a schematic diagram showing the demagnetization coil according to the embodiment.

FIG. 17A illustrates a simulation curve diagram of the demagnetizing magnetic field (demagnetizing field) in a localized region A of the magnet assembly and the adjacent region for the demagnetization coil according to one embodiment of the present disclosure.

FIG. 17B illustrates a simulation curve diagram of the decay rate (ΔH/ΔL) of the demagnetizing magnetic field at different transverse positions according to one embodiment of the present disclosure.

FIG. 18 is a schematic diagram showing the demagnetization of a localized region of a ring-shaped NdFeB magnet sample according to one embodiment of the present disclosure.

FIG. 19A illustrates a simulation curve diagram of the demagnetizing magnetic field in a localized region and the adjacent region of a circular magnetic ring for the demagnetization coil according to one embodiment of the present disclosure.

FIG. 19B illustrates a simulation curve diagram of the decay rate (ΔH/ΔL) of the demagnetizing magnetic field at different circumferential positions according to one embodiment of the present disclosure.

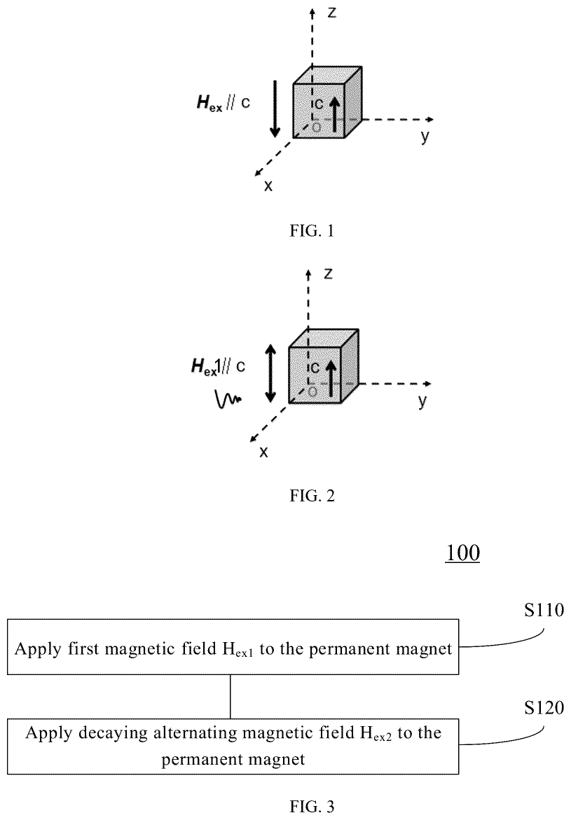

### DETAILED DESCRIPTION OF EMBODIMENTS

In order to better understand the technical solutions and advantages of the present disclosure, the following detailed description, in conjunction with the accompanying drawings and specific embodiments, further explains the content of the present disclosure. However, the specific embodiments described herein are for illustrative purposes only and are not intended to limit the present disclosure. Additionally, the technical features involved in the various embodiments described below may be combined, except in cases where there is a conflict, thereby forming other embodiments within the scope of the present disclosure.

The content described below provides numerous different embodiments or examples for implementing various structures of the present disclosure. For the sake of simplifying the disclosure of the present disclosure, specific components and configurations of particular examples are described. Of course, these are merely examples and are not intended to limit the present disclosure. Furthermore, the present disclosure may refer to numbers and/or reference letters in different examples, and such repetition is for the purpose of simplification and clarity, and does not indicate any relationship between the various embodiments and/or configurations being discussed.

The flowcharts in the accompanying drawings illustrate potential implementations of methods according to one or more embodiments of the present disclosure. It should be noted that in some alternative embodiments, the steps indicated within the boxes may not occur in the order shown in the drawings. For example, based on the functionalities involved, two or more consecutive boxes may actually be executed substantially simultaneously, or these boxes may sometimes be executed in a different order. All such embodiments fall within the scope of protection of the present disclosure.

Terms indicating orientation such as “up,” “down,” “left,” “right,” “front,” and “back” used in the present disclosure refer to the orientations as depicted in the drawings and do not represent the orientations in an actual disclosure scenario.

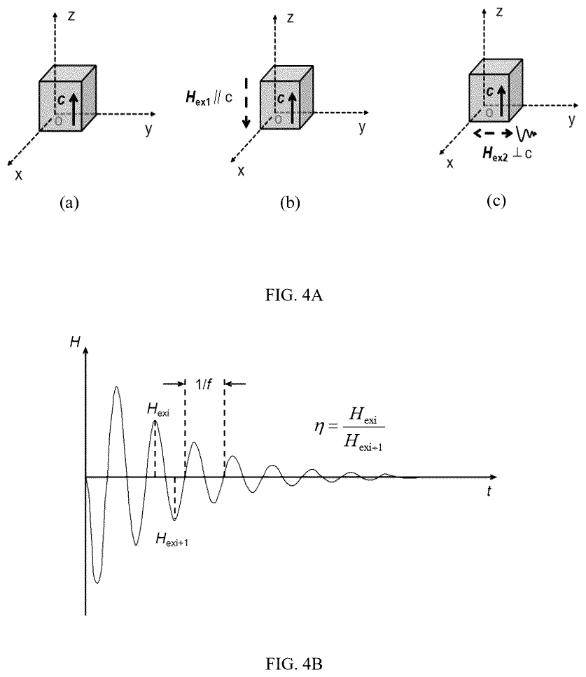

FIG. 3 illustrates a flowchart of a demagnetization method for a permanent magnet according to one embodiment of the present disclosure. FIG. 4A shows a schematic diagram of the magnetic field operation according to this embodiment. As shown in FIG. 3, the demagnetization method 100 for the permanent magnet may include steps S110 and S120. As depicted in section (a) of FIG. 4A, prior to demagnetization, the magnetization direction of the permanent magnet is denoted as c.

In step S110, a first magnetic field, Hₑₓ₁, is applied to the permanent magnet (such as, but not limited to, a neodymium-iron-boron magnet or a samarium-cobalt magnet). The direction of this first magnetic field may be parallel and opposite to the magnetization direction c of the permanent magnet, or it may be at a certain angle. This angle can range from 90° to 180°, and is in some embodiments from 120° to 180°. Section (b) of FIG. 4A illustrates one example where the direction of the first magnetic field Hₑₓ₁ is parallel and opposite to the magnetization direction c of the permanent magnet, meaning that the angle between the two is 180°.

The first magnetic field, Hₑₓ₁, may include a first unidirectional magnetic field, a first decaying alternating magnetic field, or a combination thereof. According to one embodiment, in the case where the first magnetic field Hₑₓ₁ includes a first unidirectional magnetic field, the magnitude of the component of this first unidirectional magnetic field in the magnetization direction c of the permanent magnet typically falls within the range from greater than 0 to 50 kOe inclusive. Generally, the magnitude of the component of the first unidirectional magnetic field in the magnetization direction c of the permanent magnet may be within the range from HcJ−p×HcJ to HcJ+p×HcJ, where HcJ is the intrinsic coercivity of the permanent magnet, p is a predetermined parameter, and the value of p can range from 0 to less than 1. In some embodiments, p may be within the range from 0 to 0.5 inclusive, for example, p can be 0.8, 0.72, 0.75, 0.6, 0.55, 0.5, 0.45, 0.4, 0.35, 0.3, 0.25, 0.22, 0.2, 0.15, 0.1, and so on.

According to another embodiment, in the case where the first magnetic field Hₑₓ₁ includes a first decaying alternating magnetic field, the initial magnetic field of this first decaying alternating magnetic field has a component magnitude in the magnetization direction of the permanent magnet defined as q×HcJ, where q is a predetermined parameter, and q is greater than or equal to 0.05, in some embodiments greater than or equal to 0.2. The oscillation decay frequency f of the first decaying alternating magnetic field is within the range from 5 Hz to 1000 Hz, and the oscillation decay coefficient η is a predetermined parameter (see FIG. 4B) that falls within the range from 0.20 to 0.95.

Step S110 may be similar to the reverse demagnetization discussed above, and through this step, at least a certain degree of partial demagnetization of the permanent magnet can be achieved. However, those skilled in the art will understand that, based on the direction of the first magnetic field Hₑₓ₁ and the magnitude of its components, it can be seen that in the technical solution of the disclosure, the control over the direction and magnitude of the first magnetic field Hₑₓ₁ is not strict. It may be applied within a certain angular range, and the component in the magnetization direction of the permanent magnet may take values over a broader range, thereby greatly simplifying the demagnetization operation without the need for repeated trials.

In step S120, a decaying alternating magnetic field Hₑₓ₂ is applied to the permanent magnet. The direction of the decaying alternating magnetic field may be perpendicular to the magnetization direction c of the permanent magnet or at another angle, which may range from 45° to 135°, in some embodiments from 60° to 90°. Part (c) of FIG. 4 illustrates one example where the direction of the decaying alternating magnetic field Hₑₓ₂ is perpendicular to the magnetization direction c of the permanent magnet, that is, the angle between the two is 90°, and it oscillates with decay in that direction.

According to one embodiment, the magnitude of the component of the initial magnetic field of the alternating decay magnetic field Hₑₓ₂ in the direction perpendicular to the magnetization direction c of the permanent magnet may be expressed as n×HcJ, where HcJ is the intrinsic coercivity of the permanent magnet, and n is a predetermined parameter, with n being greater than or equal to 0.2, in some embodiments greater than or equal to 1. For example, n may be 1.5, 2, 2.5, 2.8, 3, 3.5, and so on.

According to another embodiment, the oscillation decay frequency f of the decaying alternating magnetic field Hₑₓ₂ may range from 10 Hz to 1000 Hz, and the oscillation decay coefficient is a predetermined parameter η′, which represents the ratio of the amplitude after decay Hₑₓᵢ₊₁ to the amplitude before decay Hₑₓ₁ (as shown in FIG. 4B). The range of η′ may be from 0.30 to 0.95.

Step S120 corresponds to applying an alternating current decay magnetic field Hₑₓ₂ to a permanent magnet that has undergone reverse magnetic field demagnetization in step S110 (the alternating decay magnetic field Hₑₓ₂ has a component perpendicular to the magnetization direction of the permanent magnet). Under the combined influence of this decaying alternating magnetic field and any possible residual magnetism in the permanent magnet, the demagnetization process can be effectively completed, achieving the requirement that the residual magnetism approaches 0 after the external magnetic field is removed.

On the other hand, when the strength of the component of the decaying alternating magnetic field that is perpendicular to the magnetization direction of the permanent magnet is sufficiently large (for example, greater than one, two, or three times the intrinsic coercivity HcJ of the permanent magnet), it is more advantageous for canceling out any potential residual magnetism within the permanent magnet, thereby achieving the requirement that the residual magnetism approaches zero.

According to one embodiment, the aforementioned steps S110 and S120 may be performed simultaneously. For instance, the first magnetic field Hₑₓ₁ and the decaying alternating magnetic field Hₑₓ₂ can be applied to the permanent magnet concurrently, or the first magnetic field Hₑₓ₁ can be applied firstly, followed by the disclosure of the decaying alternating magnetic field Hₑₓ₂, such that the disclosure durations of both fields overlap, and so on. Those skilled in the art will understand that when steps S110 and S120 are performed simultaneously, meaning that both the first magnetic field Hₑₓ₁ and the alternating decay magnetic field Hₑₓ₂ are applied to the permanent magnet at the same time, if the first magnetic field Hₑₓ₁ comprises only the first decaying alternating magnetic field and both the frequency and direction of the first magnetic field Hₑₓ₁ and the decaying alternating magnetic field Hₑₓ₂ are identical, it can be regarded as directly applying a decaying alternating magnetic field to the permanent magnet. In this scenario, the demagnetization method of the present disclosure may consist solely of the step of applying the decaying alternating magnetic field to the permanent magnet.

According to another embodiment, steps S110 may be conducted firstly, followed by step S120, and a step of removing the first magnetic field Hₑₓ₁ may also be included between step S110 and step S120.

According to one embodiment, for the intrinsic coercivity of the permanent magnet, those skilled in the art will understand that its magnitude and magnetization direction can be roughly determined based on the specifications, model, application scenarios, and other information pertaining to the permanent magnet. Additionally, prior to step S110, the intrinsic coercivity's magnitude and direction of the permanent magnet can be measured to facilitate the determination of the magnitude and direction of the first magnetic field Hₑₓ₁ and the initial magnetic field of the decaying alternating magnetic field Hₑₓ₂ in steps S110 and S120, taking into account the shape of the magnet and its actual conditions within the magnetic circuit, especially since the precise value of the intrinsic coercivity is not required for this embodiment.

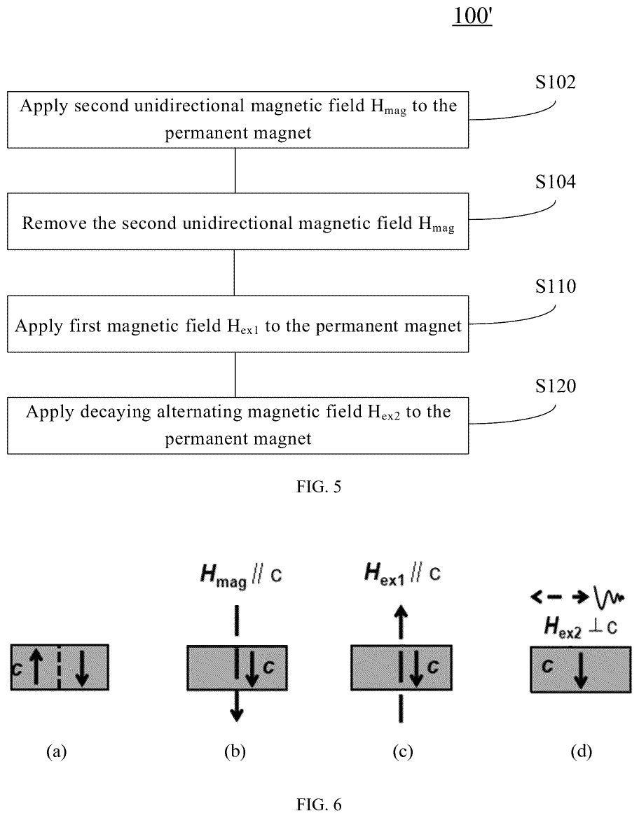

FIG. 5 illustrates a flowchart of a demagnetization method for a permanent magnet according to another embodiment of the present disclosure; FIG. 6 shows a schematic diagram of the magnetic field operations according to this embodiment. As shown in FIG. 5, in addition to steps S110 and S120, the demagnetization method 100′ for the permanent magnet may also include steps S102 and S104. As depicted in part (a) of FIG. 6, the permanent magnet is a bipolar magnet, and prior to demagnetization, different parts of the magnet have different magnetization directions; for example, the magnetization directions of different parts may be opposite or approximately opposite, or they may be at a certain angle to each other.

As shown in FIG. 5, prior to step S110, in step S102, a second magnetic field H_{mag} is applied to the permanent magnet. As illustrated in part (b) of FIG. 6, the direction of the second magnetic field H_{mag} may be parallel and identical to the magnetization direction of at least one part of the permanent magnet, or it may be at a certain angle, which can range from 0° to 180°. Part (b) of FIG. 6 illustrates one example where the direction of the second unidirectional magnetic field H_{mag} is parallel and identical to the magnetization direction c of a portion of the permanent magnet, meaning the angle between them is 0°. In this embodiment, since the permanent magnet is a multipole magnet, the direction of the second unidirectional magnetic field H_{mag} is parallel and opposite to the magnetization direction of another portion of the permanent magnet.

According to one embodiment, the magnitude of the second magnetic field H_{mag} can be determined based on the magnetic field strength required to saturate the permanent magnet in the same direction as its original magnetization or in the opposite direction. In other words, the magnetic field strength of the second magnetic field H_{mag} must be sufficient to saturate the permanent magnet in a direction parallel or antiparallel to its original magnetization direction. Those skilled in the art will understand that the magnetic field strength required for saturation can be estimated based on the specifications, models, application scenarios, and other information pertaining to the permanent magnet. Alternatively, prior to bulk demagnetization of several permanent magnets with similar physical properties, one of the permanent magnets can be measured to determine the magnetic field strength required for saturation.

Subsequently, in step S104, the second unidirectional magnetic field H_{mag} is removed.

According to this embodiment, for a multipole magnet, a unidirectional magnetic field H_{mag} is applied prior to demagnetization, thereby saturating it to a monopole state. The operations of steps S110 and S120 are then performed. In the method 100′ shown in FIG. 5, the operations of steps S110 and S120 (also see parts (c) and (d) of FIG. 6) are similar to those in FIG. 3, and thus will not be elaborated upon further for brevity. It should be noted that in this embodiment, the direction of the first magnetic field Hₑₓ₁ applied in step S110 may be opposite to the direction of the second magnetic field H_{mag} applied in step S102.

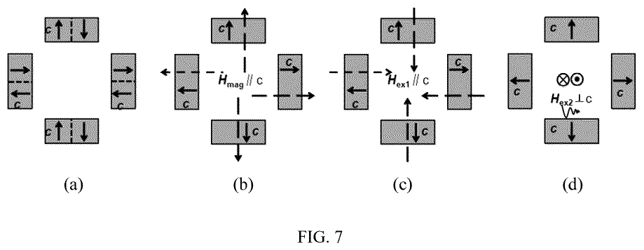

As described above, the demagnetization method for permanent magnets according to the present disclosure allows for in-situ batch demagnetization of multiple permanent magnets that constitute an assembly. FIG. 7 is a schematic diagram showing the magnetic field operations for the in-situ batch demagnetization of multiple permanent magnets according to one embodiment of the present disclosure. As shown in part (a) of FIG. 7, before performing batch demagnetization, the placement positions of the individual permanent magnets may vary, and their magnetization directions may also differ. Additionally, at least some of the permanent magnets may be multipole magnetized.

As shown in part (b) of FIG. 7, prior to demagnetization, a magnetic field H_{mag} suitable for the magnetization direction of each permanent magnet can be applied individually, thereby saturating each to a monopole state, after which the magnetic field H_{mag} is removed. The magnitude of the applied magnetic field H_{mag} can be determined as described above. Those skilled in the art will understand that if all the permanent magnets undergoing batch demagnetization are already monopole magnetized, this step can be omitted.

As shown in part (c) of FIG. 7, a first magnetic field Hₑₓ₁, which is parallel and opposite to the magnetization direction of each permanent magnet, is applied to achieve initial reverse demagnetization. Those skilled in the art will appreciate that, according to the present disclosure, the direction of the first magnetic field Hₑₓ₁ applied to each permanent magnet does not need to be perfectly parallel to the magnetization direction of each permanent magnet; it is sufficient for it to have a component in the parallel direction. The magnitude of the applied first magnetic field Hₑₓ₁ (or its component magnitude parallel to the magnetization direction of the permanent magnet) can be the same as described in step S110 above, and thus will not be elaborated on further for brevity.

As shown in part (d) of FIG. 7, an alternating decaying magnetic field Hₑₓ₂ is uniformly applied to multiple permanent magnets. In part (d) of FIG. 7, the symbols · and × indicate the direction of the decaying alternating magnetic field. The plane of the alternating decaying magnetic field Hₑₓ₂ is perpendicular to the plane of the magnetization direction c of the respective permanent magnets at this time, and it oscillates in that direction while decaying. The magnitude of the applied alternating decaying magnetic field Hₑₓ₂ can be the same as described in step S120 above, and thus will not be repeated here for brevity.

Thus, simultaneous demagnetization of multiple permanent magnets can be achieved, regardless of whether the permanent magnets are monopole magnetized, multipole magnetized, or oriented radially.

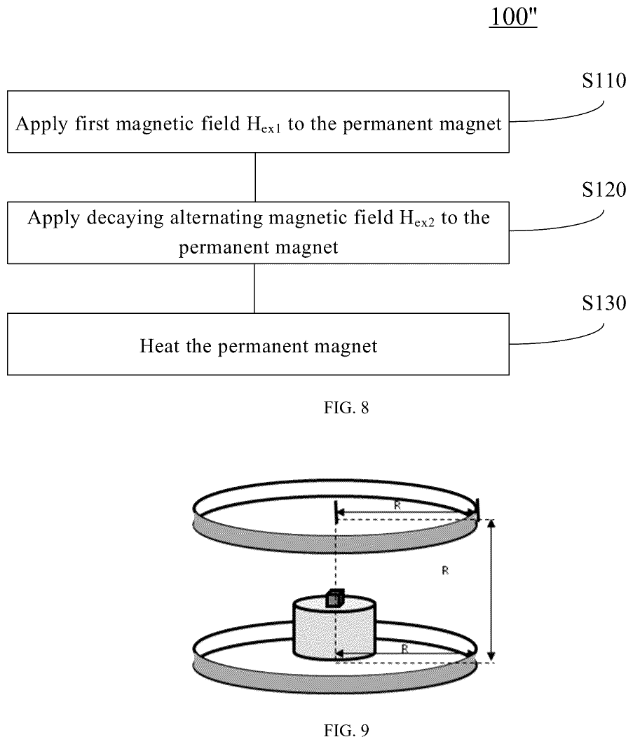

FIG. 8 illustrates a flowchart of the demagnetization method for permanent magnets according to another embodiment of the present disclosure. As shown in FIG. 8, in addition to steps S110 and S120, the demagnetization method 100″ for the permanent magnets may further include step S130. In the method 100″ illustrated in FIG. 8, the operations of steps S110 and S120 are similar to those described in FIG. 3, and for brevity, they will not be repeated here.

In step S130, the permanent magnets are subjected to heating. For example, in conjunction with steps S110 and/or S120, the permanent magnets can be heated to a temperature of 100° C. or below, thereby enabling a reduction in the external magnetic field required for demagnetization. The approach allows for the achievement of a residual magnetism close to zero after the application of a relatively low magnetic field is removed. This is particularly relevant for permanent magnets with high intrinsic coercivity, which often require a higher demagnetization field to achieve effective demagnetization. Consequently, applying a limited demagnetization field while simultaneously heating the magnets results in improved effectiveness. According to another embodiment, step S130 may also be performed before, after, and/or between steps S110 and/or S120.

The following provides a detailed description of the effects of the present disclosure, in conjunction with specific test results from the embodiment of the present disclosure and comparative embodiment.

### Embodiment 1

A cubic neodymium-iron-boron (NdFeB) permanent magnet sample was selected, with dimensions of 10 mm×10 mm×10 mm, and an intrinsic coercivity HcJ=20.0 kOe. The magnetic moment after saturation magnetization is denoted as Ms. The demagnetization process was conducted as follows:

Applying a reverse magnetic field Hₑₓ₁, parallel to its magnetization direction c, and subsequently removing it. The first component of Hₑₓ₁ in the magnetization direction has a magnetic field strength of 10.0 kOe. According to the formula, the first component of Hₑₓ₁ in the magnetization direction is given by HcJ+p×HcJ, with the parameter p set to 0.5 and using the negative sign in the formula.

Applying a decaying alternating magnetic field perpendicular to the magnetization direction c of the permanent magnet, where the third component of the initial magnetic field strength Hₑₓ₂ in the direction perpendicular to the magnetization direction is 60.0 kOe. According to the formula that the third component of Hₑₓ₂ in the direction perpendicular to the magnetization direction is n×HcJ, the value of parameter n is 3.0. The oscillating decay frequency f of Hₑₓ₂ is 100 Hz, and the oscillating decay coefficient η′ (the ratio of the latter amplitude Hₑₓᵢ₊₁ to the previous amplitude Hₑₓ₁ of the decaying field) is 0.80.

After subjecting the permanent magnet sample to the aforementioned treatment and subsequently removing the external magnetic field, the residual magnetic moment Mr obtained is measured, resulting in the ratio of the absolute value of Mr to the absolute value of the saturation magnetic moment Ms being equal to 1.1%. The absolute value of the ratio of the components of the residual magnetic moment perpendicular to the original magnetization direction and parallel to the original magnetization direction is) tan (36.7°.

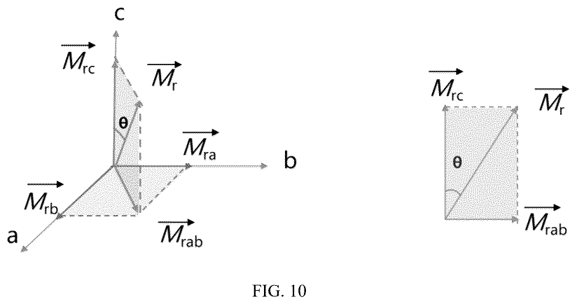

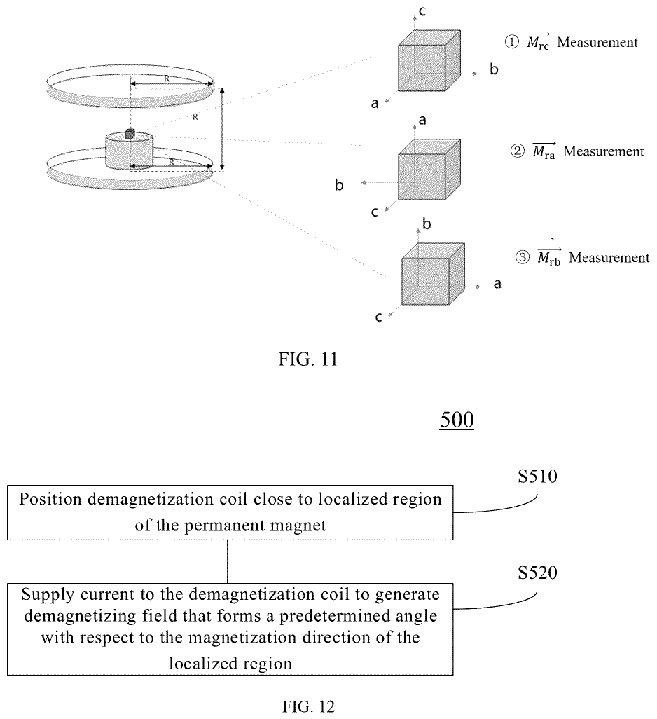

FIG. 9 illustrates a schematic of the sample measured using a Helmholtz coil. FIG. 10 shows a schematic of the magnetic moment measurement and the angle of the magnetic moment. FIG. 11 depicts a schematic of the magnetic moment measurements in different directions. The following sections will detail the measurement methods for the magnetic moment values and angles in conjunction with FIGS. 9, 10, and 11. The magnetic moment measurement method involves placing the magnetic sample within a magnetizing coil for saturation magnetization and then using a Helmholtz coil to measure the component of the magnetic moment in a specific direction (see FIG. 9).

As illustrated in FIG. 10, taking the measurement of Mr as an example: Mrc, Mra, and Mrb represent the components of the residual magnetic moment Mr in the c, a, and b directions, respectively. The measurement method involves subjecting the magnetic sample to demagnetization using the method described in this disclosure, followed by using the Helmholtz coil to measure the components of the residual magnetic moment in the c, a, and b axis directions (see FIG. 11). As shown in FIG. 10, Mrab represents the vector sum of Mra and Mrb. For example, the following equation illustrates one instance of the calculation process:

$$\vert Mrab \vert / \vert Mrc \vert = tan θ , θ = arctan ( \vert Mrab \vert / \vert Mrc \vert ) = 36.7 °$$

$$\vert Mr \vert = \sqrt{{\vert Mra \vert}^{2} + {\vert Mrb \vert}^{2} + {\vert Mrc \vert}^{2}}$$

### Embodiment 2

Selecting a cubic NdFeB permanent magnet sample with dimensions of 10 mm×10 mm×10 mm and an intrinsic coercive force denoted as HcJ=20.0 kOe. After saturation magnetization, the magnetic moment is defined as Ms. The following method is employed for the demagnetization process:

Applying a reverse magnetic field Hₑₓ₁, parallel to the magnetization direction c, and subsequently removing it. The strength of the first component of the magnetic field Hₑₓ₁ in the magnetization direction is 45.0 kOe.

Applying a decaying alternating magnetic field Hₑₓ₂ perpendicular to the magnetization direction c. The initial strength of the magnetic field Hₑₓ₂ for the third component, which is perpendicular to the magnetization direction, is 55.0 kOe. According to the formula, the third component of Hₑₓ₂ perpendicular to the magnetization direction is given by n×HcJ, where the parameter n is set to 2.75. The oscillation decay frequency f of Hₑₓ₂ is 1000 Hz, and the oscillation decay coefficient η′ is 0.95.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 1.0%. The absolute value of the ratio of the components of the residual magnetic moment that are perpendicular to the original magnetization direction and those that are parallel to the original magnetization direction is) tan (29.4°.

### Embodiment 3

A cube-shaped NdFeB permanent magnet sample is selected, with dimensions of 10 mm×10 mm×10 mm, and an intrinsic coercivity HcJ of 20.0 kOe. The magnetization after saturation is represented by Ms. The demagnetization process is conducted as follows:

Applying a unidirectional magnetic field Hₑₓ₁, which is subsequently removed. The angle between the direction of Hₑₓ₁ and the magnetization direction c of the permanent magnet sample is 138.6°. The first component of Hₑₓ₁ along the magnetization direction c has a magnetic field strength of 15.0 kOe. According to the formula, the first component of Hₑₓ₁ along the magnetization direction is HcJ+p×HcJ, where the parameter p is set to 0.25, and the negative sign is used in the formula.

Applying a decaying alternating magnetic field perpendicular to the magnetization direction c. The initial magnetic field Hₑₓ₂ has a strength of 50.0 kOe in the third component, which is perpendicular to the magnetization direction. According to the formula, the third component of Hₑₓ₂ is n×HcJ, where the parameter n is set to 2.5. The oscillation decay frequency f of Hₑₓ₂ is 250 Hz, and the oscillation decay coefficient η′ is 0.60.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 1.2%. The absolute value of the ratio of the components of the residual magnetic moment that are perpendicular to the original magnetization direction and those that are parallel to the original magnetization direction is) tan (32.2°.

### Embodiment 4

A cube-shaped NdFeB permanent magnet sample is selected, with dimensions of 10 mm×10 mm×10 mm, and an intrinsic coercivity HcJ of 20.0 kOe. The magnetization after saturation is represented by Ms. The demagnetization process is conducted as follows:

Applying a unidirectional magnetic field Hₑₓ₁. The angle between the direction of Hₑₓ₁ and the magnetization direction c of the permanent magnet sample is 107.5°. The first component of Hₑₓ₁ along the magnetization direction c has a magnetic field strength of 18.0 kOe. According to the formula, the first component of Hₑₓ₁ along the magnetization direction is HcJ+p×HcJ, where the parameter p is set to 0.1, and the negative sign is used in the formula.

Simultaneously applying a decaying alternating magnetic field, with the angle between the direction of the alternating field and the magnetization direction c being 66.4°. The initial magnetic field Hₑₓ₂ has a strength of 48.0 kOe in the third component, which is perpendicular to the magnetization direction c. According to the formula, the third component of Hₑₓ₂ is n×HcJ, where the parameter n is set to 2.4. The oscillation decay frequency f of Hₑₓ₂ is 50 Hz, and the oscillation decay coefficient η′ is 0.50.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 1.3%. The absolute value of the ratio of the components of the residual magnetic moment that are perpendicular to the original magnetization direction and those that are parallel to the original magnetization direction is) tan (20.8°.

### Embodiment 5

A cube-shaped NdFeB permanent magnet sample is selected, with dimensions of 10 mm×10 mm×10 mm, and an intrinsic coercivity HcJ of 20.0 kOe. The magnetization after saturation is denoted as Ms. The demagnetization is conducted as follows:

Applying a reverse magnetic field Hₑₓ₁ parallel to the magnetization direction c and subsequently removing it. The magnetic field strength of the first component of Hₑₓ₁ along the magnetization direction is 22.0 kOe. According to the formula, the first component of Hₑₓ₁ along the magnetization direction is HcJ+p×HcJ, where the parameter p is set to 0.1, and the positive sign is used in the formula.

Applying a decaying alternating magnetic field, with the angle between the direction of the alternating field and the magnetization direction c being 45.0°. The initial magnetic field Hₑₓ₂ has a third component in the direction perpendicular to the magnetization direction c, with a magnetic field strength of 42.0 kOe. According to the formula, the third component of Hₑₓ₂ perpendicular to the magnetization direction is n×HcJ, where the parameter n is set to 2.1. The oscillation decay frequency f of Hₑₓ₂ is 107 Hz, and the oscillation decay coefficient η′ is 0.75.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 2.0%. The absolute value of the ratio of the components of the residual magnetic moment that are perpendicular to the original magnetization direction and those that are parallel to the original magnetization direction is) tan (28.2°.

### Embodiment 6

A rectangular NdFeB permanent magnet sample is selected, with dimensions of 9 mm×3 mm×4 mm, and an intrinsic coercivity HcJ of 20.0 kOe. The magnetization after saturation is denoted as Ms. The demagnetization is conducted as follows:

Applying a reverse magnetic field Hₑₓ₁ parallel to the magnetization direction c and subsequently removing it. The magnetic field strength of the first component of Hₑₓ₁ along the magnetization direction is 20.0 kOe. According to the formula, the first component of Hₑₓ₁ along the magnetization direction is HcJ+p×HcJ, where the parameter p is set to 0.0.

Applying a decaying alternating magnetic field perpendicular to the magnetization direction c, with the initial magnetic field Hₑₓ₂ having a third component perpendicular to the magnetization direction with a strength of 40.0 kOe. According to the formula, the third component of Hₑₓ₂ perpendicular to the magnetization direction is n×HcJ, where the parameter n is set to 2.0. The oscillation decay frequency f of Hₑₓ₂ is 21 Hz, and the oscillation decay coefficient η′ is 0.30.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 2.5%. The absolute value of the ratio of the components of the residual magnetic moment that are perpendicular to the original magnetization direction and those that are parallel to the original magnetization direction is) tan (17.2°.

### Embodiment 7

Selecting a rectangular cuboid samarium-cobalt permanent magnet sample with dimensions of 9 mm×3 mm×4 mm and an intrinsic coercivity HcJ=20.0 kOe. After saturation magnetization, the initial magnetic moment is Ms. Demagnetizing the sample involves the following processes:

Applying a reverse magnetic field Hₑₓ₁ parallel to the magnetization direction c, then removing it. The magnetic field strength of the first component of Hₑₓ₁ along the magnetization direction is 22.0 kOe. According to the formula, the first component of Hₑₓ₁ along the magnetization direction is HcJ+p×HcJ, where the parameter p is set to 0.1, and the positive sign is taken.

Applying a decaying alternating magnetic field Hₑₓ₂ perpendicular to the magnetization direction c, with an initial magnetic field strength of 43.0 kOe for the third component perpendicular to the magnetization direction. According to the formula, the third component of Hₑₓ₂ is n×HcJ, where the parameter n is set to 2.15. The oscillation decay frequency f is 100 Hz, and the decay coefficient η′ is 0.80.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 1.9%. The absolute value of the ratio of the components of the residual magnetic moment that are perpendicular to the original magnetization direction and those that are parallel to the original magnetization direction is) tan (28.6°.

### Embodiment 8

Selecting a permanent magnet sample assembly composed of four rectangular cuboid NdFeB permanent magnet samples arranged in the layout shown in FIG. 7. Each rectangular permanent magnet has dimensions of 9 mm×3 mm×4 mm and an intrinsic coercivity HcJ=20.0 kOe. Demagnetizing the samples involves the following processes:

Applying a unidirectional magnetic field H_{mag} parallel to at least a portion of the magnetic domains of each permanent magnet in the sample assembly, and then removing it. The magnetic field strength of H_{mag} is 47.0 kOe. After removing H_{mag}, each permanent magnet sample achieves saturation magnetization, with the initial magnetic moment after saturation being Ms.

Applying a reverse magnetic field Hₑₓ₁ parallel to the magnetization direction c for each permanent magnet in the sample assembly, and then removing it. The magnetic field strength of the first component of Hₑₓ₁ along the magnetization direction is 25.0 kOe. According to the formula, the first component of Hₑₓ₁ along the magnetization direction is HcJ+p×HcJ, where the parameter p is set to 0.25, and the positive sign is taken.

Applying a decaying alternating magnetic field Hₑₓ₂ perpendicular to the magnetization direction c, with an initial magnetic field strength of 58.0 kOe for the third component perpendicular to the magnetization direction. According to the formula, the third component of Hₑₓ₂ is n×HcJ, where the parameter n is set to 2.9. The oscillation decay frequency f is 100 Hz, and the decay coefficient η′ is 0.80.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 1.3%. The absolute value of the ratio of the components of the residual magnetic moment that are perpendicular to the original magnetization direction and those that are parallel to the original magnetization direction is) tan (39.4°.

### Embodiment 9

Selecting a permanent magnet sample assembly composed of four rectangular cuboid NdFeB permanent magnet samples arranged in the layout shown in FIG. 7. Each rectangular permanent magnet has dimensions of 9 mm×3 mm×4 mm and an intrinsic coercivity HcJ=20.0 kOe. Demagnetizing the samples involves the following processes:

Applying a unidirectional magnetic field H_{mag} parallel to at least a portion of the magnetic domains of each permanent magnet in the sample assembly, and then removing it. The magnetic field strength of H_{mag} is 58.0 kOe. After removing H_{mag}, each permanent magnet sample achieves saturation magnetization, with the initial magnetic moment after saturation being Ms.

Applying a reverse magnetic field Hₑₓ₁ parallel to the magnetization direction c for each permanent magnet in the sample assembly, and then removing it. The magnetic field strength of the first component of Hₑₓ₁ along the magnetization direction is 30.0 kOe. According to the formula, the first component of Hₑₓ₁ parallel to the magnetization direction is HcJ+p×HcJ, where the parameter p is set to 0.5, and the positive sign is taken.

Applying a decaying alternating magnetic field Hₑₓ₂ perpendicular to the magnetization direction c, with an initial magnetic field strength of 62.0 kOe for the third component perpendicular to the magnetization direction. According to the formula, the third component of Hₑₓ₂ is n×HcJ, where the parameter n is set to 3.1. The oscillation decay frequency f is 100 Hz, and the decay coefficient η′ is 0.80.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 1.9%. The absolute value of the ratio of the components of the residual magnetic moment that are perpendicular to the original magnetization direction and those that are parallel to the original magnetization direction is) tan (28.2°.

### Embodiment 10

Selecting a cubic neodymium-iron-boron permanent magnet sample with dimensions of 10 mm×10 mm×10 mm and an intrinsic coercivity HcJ=30.0 kOe, with the initial magnetic moment after saturation being Ms. Demagnetizing the sample involves the following processes:

Applying a decaying current magnetic field Hₑₓ₁ parallel to the magnetization direction c. The magnetic field strength of the first component of Hₑₓ₁ along the magnetization direction is 15.0 kOe. According to the formula, the first component of Hex along the magnetization direction is q×HcJ, where the parameter q is set to 0.5. The oscillation decay frequency f is 107 Hz, and the decay coefficient η is 0.85.

After completing the previous process, heating the sample and maintaining it at 80° C. while simultaneously applying a decaying alternating magnetic field. The direction of this decaying alternating magnetic field is perpendicular to the magnetization direction c of the permanent magnet sample, with an initial magnetic field strength Hₑₓ₂ of 55.0 kOe for the third component perpendicular to the magnetization direction. According to the formula, the third component of Hₑₓ₂ perpendicular to the magnetization direction is q×HcJ, where the parameter q is set to 1.83. The oscillation decay frequency f is 100 Hz, and the decay coefficient η′ is 0.80.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 0.3%. The absolute value of the ratio of the components of the residual magnetic moment that are perpendicular to the original magnetization direction and those that are parallel to the original magnetization direction is) tan (21.6°.

### Embodiment 11

Selecting a cubic neodymium-iron-boron permanent magnet sample with dimensions of 10 mm×10 mm×5 mm and an intrinsic coercivity HcJ=16.60 kOe, with the magnetic moment after saturation being Ms. Demagnetizing the sample involves the following processes:

Applying a decaying alternating magnetic field Hₑₓ₂ perpendicular to the magnetization direction c, with an initial magnetic field strength of Hₑₓ₂ at 50.0 kOe for the third component perpendicular to the magnetization direction. According to the formula, the third component of Hₑₓ₂ perpendicular to the magnetization direction is n×HcJ, where the parameter n is set to 3.0. The oscillation decay frequency f is 100 Hz, and the decay coefficient η′ (the ratio of the amplitude after the decay field Hₑₓᵢ₊₁ to the amplitude before the decay Hₑₓ₁) is 0.70.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 2.1%. The absolute value of the ratio of the components of the residual magnetic moment that are perpendicular to the original magnetization direction and those that are parallel to the original magnetization direction is) tan (43.4°.

### Embodiment 12

Selecting a cubic neodymium-iron-boron permanent magnet sample with dimensions of 8 mm×8 mm×20 mm and an intrinsic coercivity HcJ=23.0 kOe, with the magnetic moment after saturation being Ms. Demagnetizing the sample involves the following processes:

Applying a decaying alternating magnetic field Hₑₓ₂ perpendicular to the magnetization direction c, with an initial magnetic field strength of Hₑₓ₂ at 70.0 kOe for the third component perpendicular to the magnetization direction. According to the formula, the third component of Hₑₓ₂ perpendicular to the magnetization direction is n×HcJ, where the parameter n is set to 3.0. The oscillation decay frequency f is 100 Hz, and the decay coefficient η′ (the ratio of the amplitude after the decay field Hₑₓᵢ₊₁ to the amplitude before the decay Hₑₓ₁) is 0.85.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 1.8%. The absolute value of the ratio of the components of the residual magnetic moment that are perpendicular to the original magnetization direction and those that are parallel to the original magnetization direction is tan (56.3°).

### Embodiment 13

Selecting a cylindrical NdFeB permanent magnet sample with dimensions of φ15 mm 20 mm and an intrinsic coercivity HcJ=12.0 kOe, with the magnetic moment after saturation being Ms. Demagnetizing the sample involves the following processes:

Applying a decaying alternating magnetic field Hₑₓ₂ at an angle of 80° to the magnetization direction c of the permanent magnet sample. The initial magnetic field Hₑₓ₂ has a third component directed perpendicular to the magnetization direction c, with a magnetic field strength of 49.2 kOe. According to the formula, the third component of Hₑₓ₂ perpendicular to the magnetization direction is n×HcJ, where the parameter n is set to 4.1. The oscillation decay frequency f is 100 Hz, and the decay coefficient η′ (the ratio of the amplitude after the decay field Hₑₓᵢ₊₁ to the amplitude before the decay Hₑₓ₁) is 0.6.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 0.94%. The absolute value of the ratio of the components of the residual magnetic moment that are perpendicular to the original magnetization direction and those that are parallel to the original magnetization direction is) tan (66.4°.

### Embodiment 14

Selecting a cylindrical neodymium-iron-boron permanent magnet sample with dimensions of φ15 mm×20 mm and an intrinsic coercivity HcJ=12.0 kOe, with the magnetic moment after saturation being Ms. Demagnetizing the sample involves the following processes:

Applying a decaying alternating magnetic field Hₑₓ₂ at an angle of 130° to the magnetization direction c of the permanent magnet sample. The initial magnetic field Hₑₓ₂ has a third component directed perpendicular to the magnetization direction c, with a magnetic field strength of 46.0 kOe. According to the formula, the third component of Hₑₓ₂ perpendicular to the magnetization direction is n×HcJ, where the parameter n is set to 3.8. The oscillation decay frequency f is 100 Hz, and the decay coefficient η′ (the ratio of the amplitude after the decay field Hₑₓᵢ₊₁ to the amplitude before the decay Hₑₓ₁) is 0.6.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 1.2%. The absolute value of the ratio of the components of the residual magnetic moment that are perpendicular to the original magnetization direction and those that are parallel to the original magnetization direction is) tan (60.5°.

### Comparative Embodiment 1 (Traditional Reverse Magnetic Field Demagnetization)

Selecting a cubic neodymium-iron-boron permanent magnet sample with dimensions of 10 mm×10 mm×10 mm and intrinsic coercivity HcJ=20.0 kOe, with the magnetic moment after saturation being Ms. Demagnetizing the sample involves the following processes:

Applying a reverse magnetic field Hₑₓ₁ parallel to the magnetization direction c and then removed, the magnetic field strength of Hₑₓ₁=18.0 kOe.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 49.2%. The absolute value of the ratio of the components of the residual magnetic moment that are perpendicular to the original magnetization direction and those that are parallel to the original magnetization direction is) tan (0.8°.

### Comparative Embodiment 2 (Traditional Reverse Magnetic Field Demagnetization)

Selecting a cubic neodymium-iron-boron permanent magnet sample with dimensions of 10 mm×10 mm×10 mm and intrinsic coercivity HcJ=20.0 kOe, with the magnetic moment after saturation being Ms. Demagnetizing the sample involves the following processes:

Applying a reverse magnetic field Hₑₓ₁ parallel to the magnetization direction c and then removed, the magnetic field strength of Hₑₓ₁=22.0 kOe.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 45.8%. The absolute value of the ratio of the components of the residual magnetic moment that are perpendicular to the original magnetization direction and those that are parallel to the original magnetization direction is tan (1.3°).

### Comparative Embodiment 3 (Traditional Reverse Magnetic Field Demagnetization)

Selecting a cubic neodymium-iron-boron permanent magnet sample with dimensions of 10 mm×10 mm×10 mm and intrinsic coercivity HcJ=20.0 kOe, with the magnetic moment after saturation being Ms. Demagnetizing the sample involves the following processes:

Applying a reverse magnetic field Hₑₓ₁ parallel to the magnetization direction c and then removed, the magnetic field strength of Hₑₓ₁=20.0 kOe.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 9.4%. The absolute value of the ratio of the components of the residual magnetic moment that are perpendicular to the original magnetization direction and those that are parallel to the original magnetization direction is) tan (1.6°.

### Comparative Embodiment 4 (Traditional Decaying Alternating Magnetic Field Demagnetization)

Selecting a cubic neodymium-iron-boron permanent magnet sample with dimensions of 10 mm×10 mm×10 mm and intrinsic coercivity HcJ=20.0 kOe, with the magnetic moment after saturation being Ms. Demagnetizing the sample involves the following processes:

Applying a decaying current magnetic field parallel to the magnetization direction c. The initial magnetic field strength is 30.0 kOe. The oscillation decay frequency f is 100 Hz, and the decay coefficient η is 0.8.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 96.6%. The absolute value of the ratio of the components of the residual magnetic moment that are perpendicular to the original magnetization direction and those that are parallel to the original magnetization direction is) tan (1.7°.

### Comparative Embodiment 5 (Traditional Decaying Alternating Magnetic Field Demagnetization)

Selecting a cubic neodymium-iron-boron permanent magnet sample with dimensions of 10 mm×10 mm×10 mm and intrinsic coercivity HcJ=20.0 kOe, with the magnetic moment after saturation being Ms. Demagnetizing the sample involves the following processes:

Applying a decaying current magnetic field parallel to the magnetization direction c. The initial magnetic field strength is 45.0 kOe. The oscillation decay frequency f is 100 Hz, and the decay coefficient η is 0.8.

Subjecting the permanent magnet sample to the aforementioned treatment and subsequently removing the external magnetic field yields a residual magnetic moment denoted as Mr, with the ratio of the absolute value of Mr to the absolute value of the saturation magnetic moment Ms equaling 95.2%. The absolute value of the ratio of the components of the residual magnetic moment that are perpendicular to the original magnetization direction and those that are parallel to the original magnetization direction is) tan (2.5°.

Based on the experimental results summarized above, it can be observed that the magnets demagnetized using the various embodiments of the present disclosure exhibit a relatively low residual magnetization. Typically, the magnitude of the remaining magnetic moment, compared to the original magnetization direction's saturation magnetization, has a ratio of less than 5%, and in some embodiments less than 3%. In contrast, magnets demagnetized using conventional methods often retain a high level of residual magnetization, making it difficult to achieve the requirement for residual magnetization to approach zero. Furthermore, the magnets demagnetized using the embodiments of the present disclosure demonstrate that the absolute value of the ratio of the component of the remaining magnetic moment perpendicular to the original magnetization direction to that parallel to the original magnetization direction is greater than) tan (5°, and in some embodiments greater than) tan (10°. For example, the absolute value of this ratio may be) tan (15°), tan (20°), tan (25°), tan (30°), tan (35°), tan (40°, etc.

Furthermore, the inventors have noted that permanent magnet components, such as those used in motors and wireless charging for mobile phones, are typically produced using a process where assembly is first performed without magnetization, followed by magnetizing the entire component or part.

In certain specialized application areas, to meet the magnetic field requirements within the entire magnetic circuit, it may be needed for the magnetic field strength in a specific localized region of the magnet assembly to be significantly lower than in other areas, while the magnetic field strength of the magnets or parts of the magnets outside this localized region remains uniform. To achieve this effect, magnetizing the entire assembly after the magnets have been assembled into a single unit may be involved, or individual magnets may be magnetized after they have been integrally formed, wherein the localized region of the magnet is left unmagnetized while other areas are magnetized.

However, due to the magnetization characteristics of sintered NdFeB permanent magnets, the unmagnetized localized regions of the magnets often become influenced by the surrounding magnetizing magnetic fields during this process, resulting in weak magnetism on the surface of the localized area, which may lead to a surface magnetic field strength exceeding the designed magnetic field strength and failing to meet design specifications.

To address this issue, in conjunction with the embodiments described above, the present disclosure also provides a method, device, and magnet for demagnetizing the localized region of a permanent magnet.

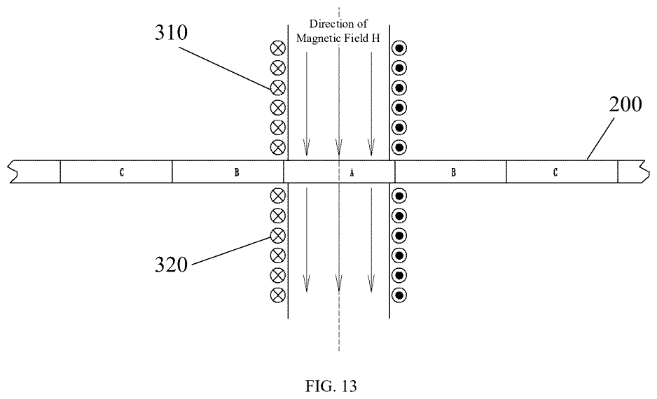

FIG. 12 illustrates a flowchart of a demagnetization method for a localized region of a permanent magnet according to one embodiment of the present disclosure; FIG. 13 is a schematic diagram showing the demagnetization operation according to this embodiment. As depicted in FIGS. 12 and 13, the demagnetization method 500 for the localized region of the permanent magnet may include steps S510 and S520.

Prior to the operation of step S510, the entire permanent magnet 200 (such as, but not limited to, a neodymium-iron-boron magnet) has been fully magnetized, achieving the magnetic strength and direction required by the design. The permanent magnet 200 may be a magnet assembly composed of multiple smaller magnets (which can be seen in FIG. 13 as magnets A, B, and C, where each magnet exhibits substantially the same magnetic performance); alternatively, the permanent magnet 200 can also be a single magnet that is integrally formed (which can be viewed in FIG. 13 as a single magnet including regions A, B, and C, where each region exhibits substantially the same magnetic performance). In the permanent magnet 200, the localized region A requires demagnetization, which refers to the specific area that needs to be demagnetized according to the design specifications. The localized region A can be a portion of the integrally formed permanent magnet 200 or one or more magnets in a laminated magnet assembly.

In step S510, a demagnetization coil is positioned close to the localized region A of the permanent magnet 200. As depicted in FIG. 13, the demagnetization coil may include an upper coil 310 positioned above the localized region A and a lower coil 320 positioned below the localized region A. In the present disclosure, the permanent magnet 200 can take on a rectangular shape, a ring shape, or any other shape required by the design.

In step S520, current is supplied to the demagnetization coil to generate a demagnetizing field that forms a predetermined angle with respect to the magnetization direction of the localized region A. As shown in FIG. 13, the magnetic field directions generated by the upper coil 310 and the lower coil 320 are the same. According to one embodiment of the present disclosure, the predetermined angle may be in the range of 90°+8°, and in some embodiments within 90°+3°. This means that, referring to FIG. 13, prior to utilizing method 500 for demagnetization, the magnetization direction of the localized region A of the permanent magnet 200 is substantially perpendicular to the plane of the paper.

According to one embodiment of the present disclosure, the demagnetizing field produced by the demagnetization coil may be a pulse magnetic field or a decaying alternating magnetic field, in some embodiments the decaying alternating magnetic field.

Thus, to achieve a magnet or magnet assembly where the magnetic strength in a specific localized region is significantly lower than in surrounding areas, the entire magnet or magnet assembly can first be fully magnetized (meaning that the specific localized region is also magnetized), and then demagnetization can be performed on that specific localized region. Moreover, the direction of the demagnetizing magnetic field is substantially perpendicular to the magnetization direction of the localized region to be demagnetized. On one hand, this configuration allows for effective demagnetization of the localized region while minimizing any impact on the magnetization strength of adjacent areas. On the other hand, the demagnetization method of the present disclosure also avoids the issues encountered in the related art where a magnetic field completely opposite to the magnetization strength of the magnet is used for demagnetization, which often requires high intensity and precise control of the reverse magnetic field.

According to one embodiment of the present disclosure, the maximum magnetic field strength of the demagnetizing field generated by the demagnetization coil acting on the localized region A satisfies the following equation:

$$2.1 \times HcJ / μ r \leq H \leq 3.5 \times HcJ / μ r$$

where H is the magnetic field strength of the demagnetizing field, HcJ is the intrinsic coercivity of the localized region A of the permanent magnet 200, and μr is the relative permeability of the localized region A.

Thus, when setting the magnitude of the demagnetizing field produced by the demagnetization coil, this configuration ensures that the generated field strength is sufficiently large (H≥2.1×HcJ/μr) to achieve a good demagnetization effect in the localized region A. On the other hand, if the demagnetizing field strength is too high, the demagnetized area will increase, thereby enlarging the transition zone between the demagnetized and non-demagnetized regions, which can weaken the precise control of the demagnetized area. Therefore, the condition H≤3.5×HcJ/μr effectively prevents this situation from occurring.

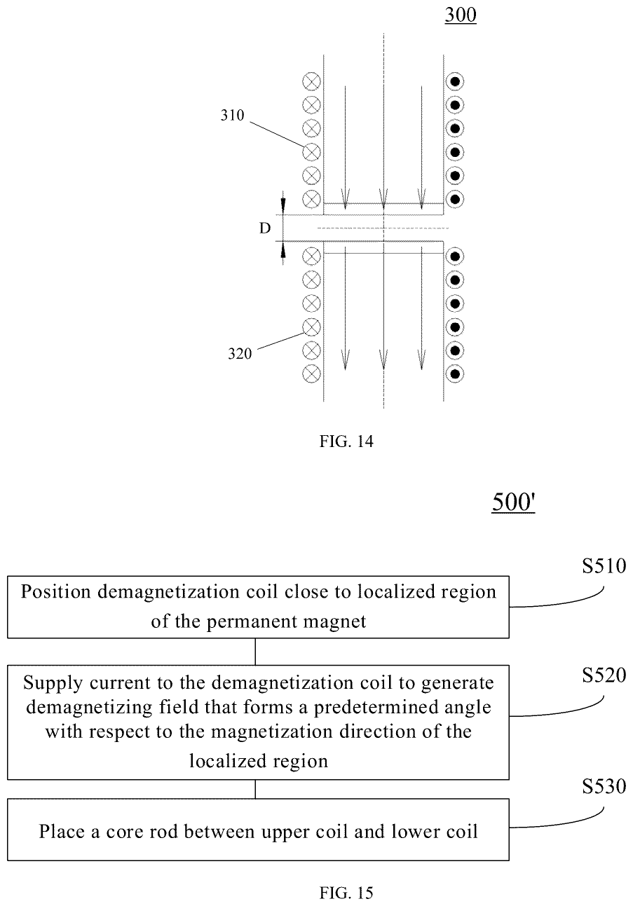

FIG. 14 illustrates a schematic view of the gap setting between the upper coil and the lower coil according to one embodiment of the present disclosure. As shown in FIG. 14, there is a gap D between the upper coil 310 and the lower coil 320, which is designed to accommodate the localized region A to be demagnetized. The gap D (measured in mm) satisfies the following condition:

$$D \leq 10 / μ r$$

where μr is the relative permeability of the localized region A of the permanent magnet 200.

Consequently, the gap between the upper coil and the lower coil is set as small as possible to prevent the magnet from vibrating and/or deflecting during the application of the demagnetizing field. Additionally, if the gap between the upper coil and the lower coil is too large, the demagnetizing field at the edges of the coils may also affect the magnetization strength of non-demagnetized regions outside the localized region A to be demagnetized, potentially leading to partial demagnetization of those areas.

According to one embodiment of the present disclosure, the magnetic field strength of the demagnetizing field produced by the demagnetization coil has a maximum decay slope at the edge region of the coil of greater than or equal to 0.5 T/mm, and in some embodiments greater than or equal to 0.7 T/mm. The demagnetizing field generated by the coil in regions outside the projection area of the magnet or magnetic assembly is smaller. To minimize the influence of the demagnetizing field on regions outside the localized area A to be demagnetized, the decay slope of the demagnetizing field needs to be greater as the distance from the edge of the projection area increases. In other words, the magnetic field strength generated by the demagnetization coil at its edges will decrease sharply as one moves away from the localized area to be demagnetized.

For example, when using sintered neodymium-iron-boron magnets as permanent magnets, the inventors have found that when a demagnetizing field H is applied perpendicular to the magnetization direction after the sintered neodymium-iron-boron magnet has been fully magnetized, a magnetic field strength value of H≥2.1× HcJ will achieve a good demagnetization effect. Specifically, this results in the localized area A being demagnetized to an extent such that M/Mₘₐₓ<30% (where M is the magnetic moment after demagnetization of localized area A and Mₘₐₓ is the saturation magnetic moment of localized area A). However, since the magnetic circuit is open, the demagnetizing magnetic field also affects the non-demagnetized region B surrounding the localized area A that is to be demagnetized. When the strength of the demagnetizing field acting on the surface of region B reaches 1.5× HcJ, it adversely affects the surface magnetization strength of the non-demagnetized region B, which is undesirable. Therefore, it is needed for the demagnetizing field to be concentrated in the localized area A while minimizing the impact on the non-demagnetized region B. Consequently, it is essential to control the decay slope of the demagnetizing field with respect to the distance from the edge of the demagnetization coil, thereby ensuring that the area affected by the demagnetizing magnetic field is confined to the localized area A that is to be demagnetized.

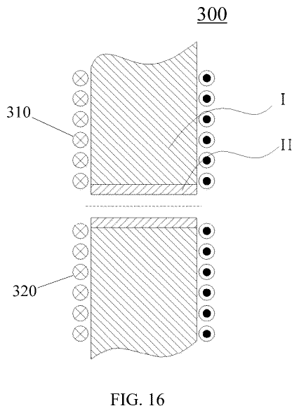

FIG. 15 illustrates a flowchart of a demagnetization method for a localized area of a permanent magnet according to another embodiment of the present disclosure. FIG. 16 shows a schematic diagram of the demagnetization coil according to this embodiment. As shown in method 500′ in FIG. 15, in addition to steps S510 and S520, the demagnetization method for the localized area of the permanent magnet may also include step S530. The operations of steps S510 and S520 are similar to those in FIG. 12, and thus will not be reiterated here for brevity.

In step S530, a core rod 330 is placed between the upper coil 310 and the lower coil 320. The portion I of the core rod 330 that is away from the localized area A (not shown in FIG. 16) is made of a magnetic conductive material, while the portion II of the core rod 330 that is adjacent to the localized area A is made of a non-magnetic material. This configuration allows the magnetic conductive material portion I to enhance the magnetic field generated by the demagnetization coil, while the non-magnetic material portion II helps to prevent the localized area A from being attracted to the demagnetization coil during or after the demagnetization operation, making removal inconvenient.

According to another embodiment of the present disclosure, a device for demagnetizing a localized area of a permanent magnet is also provided. Referring to FIGS. 13 and 14, the device 300 may include an upper coil 310 and a lower coil 320. The upper coil 310 is positioned above the localized area A of the permanent magnet that is to be demagnetized, while the lower coil 320 is positioned below the localized area A and is opposite the upper coil 310. The magnetic field directions generated by the upper coil 310 and the lower coil 320 are the same and oriented at a predetermined angle relative to the magnetization direction of the localized area A, based on the demagnetization requirements for the localized area to be demagnetized.

Referring again to FIG. 16, the device 300 may further include a core rod 330. The core rod 330 comprises an upper core rod and a lower core rod, which are respectively positioned within the upper coil 310 and the lower coil 320. The portion of the core rod 330 that is away from the localized area A to be demagnetized is made of a magnetic conductive material to enhance the magnetic fields generated by the upper coil 310 and the lower coil 320. The portion of the core rod 330 that is adjacent to the localized area A to be demagnetized is made of a non-magnetic material to prevent the localized area A from being attracted to the upper coil 310 and/or the lower coil 320 during or after the demagnetization operation, thereby facilitating easier removal.

### Embodiment 21

A strip-shaped neodymium-iron-boron permanent magnet sample (as shown in FIG. 13) is selected, assembled from multiple magnets to form a magnet assembly. Each individual magnet has the following dimensions: thickness of 2.0 mm, width of 4.5 mm (magnetization direction), length of 8.3 mm, with μr=1.226 and HcJ=12 kOe. The magnetization direction of the magnet assembly is perpendicular to the plane of the paper. The present disclosure provides a method for magnetizing the sample and subsequently demagnetizing a localized area A, as follows:

Magnetizing the magnet assembly using a 2.5 T magnetizing magnetic field, wherein each individual magnet reaches a saturation magnetic moment value of Mₘₐₓ in the 2.5 T magnetizing magnetic field.

Positioning a demagnetization coil near the localized area A of the permanent magnet. The demagnetization coil includes an upper coil and a lower coil, with the upper coil located above the localized area A and the lower coil located below it. The upper and lower coils each generate an alternating decay magnetic field in the same direction. The gap D between the upper coil and the lower coil is 3.0 mm, and the direction of the magnetic field is at a 90° angle to the magnetization direction of the individual magnets, designed to achieve a maximum demagnetization field strength H of 2.7 T in the demagnetization region.

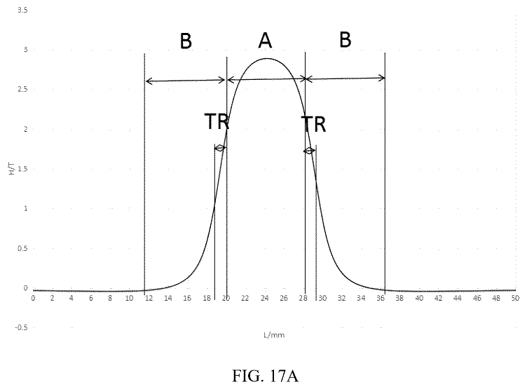

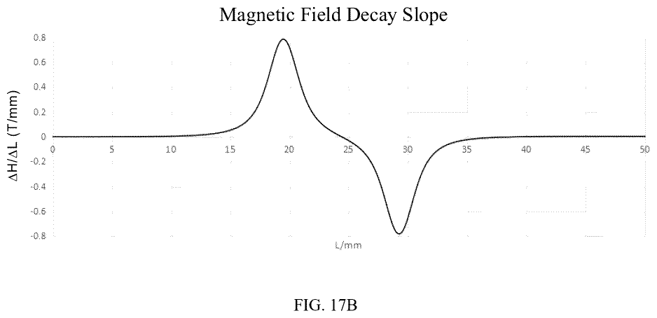

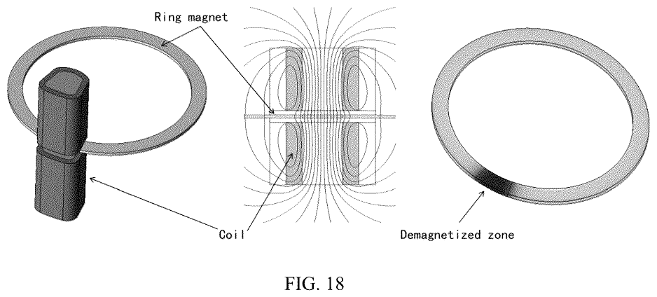

Supplying current to the demagnetization coil to generate a demagnetization field that is at a 90° angle to the magnetization direction of the localized area A of the magnet assembly after magnetization. FIG. 17A illustrates the simulated demagnetization magnetic field curve of the demagnetization coil in the localized area A of the magnet assembly and its adjacent regions, where the horizontal axis represents the transverse position L of the magnet assembly in mm, and the vertical axis represents the demagnetization field strength generated by the demagnetization coil in T, with TR indicating the edge region of the demagnetization coil. FIG. 17B depicts the simulated curve of the decay slope of the demagnetization field (ΔH/ΔL) at different transverse positions, with |ΔH/ΔL|max=0.8 T/mm.

After completing the localized demagnetization, removing individual magnets A, B, and C from the magnet assembly (as shown in FIG. 13) and measuring their magnetic moments M. Table 1 presents the measured results of the M/Mₘₐₓ ratio.

TABLE 1

| Position | M/Mₘₐₓ % |
|---|---|
| A | 13 |
| B | 98 |
| C | 100 |

### Embodiment 22

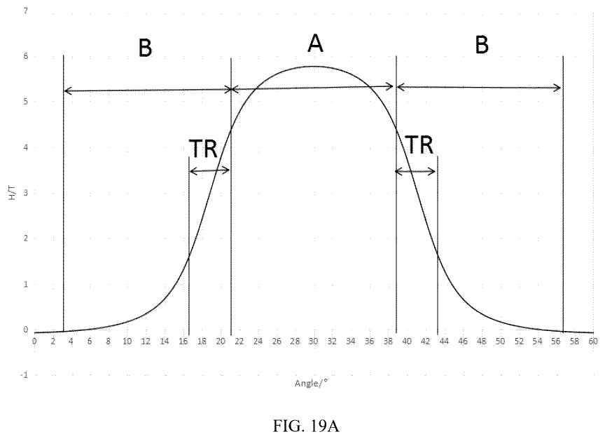

A circular ring-shaped neodymium-iron-boron permanent magnet sample (as shown in FIG. 18) is selected, consisting of multiple magnets assembled into a magnet assembly. The outer diameter D1 of the circular magnet ring assembly is 54 mm, and the inner diameter D2 is 46 mm. Each individual magnet corresponds to a central angle of 18° and has a thickness of 1.0 mm. Each individual magnet has a magnetic permeability of μr=1.022 and a coercive force HcJ=25 kOe, with the magnetization direction of the assembly oriented radially towards the ring. The present disclosure employs the following method for magnetizing the sample and subsequently demagnetizing a localized area A.

Initially, magnetizing the circular magnet ring assembly using a 2.5 T magnetic field, wherein each individual magnet reaches a saturation magnetic moment value of Mₘₐₓ in the 2.5 T field.

Positioning a demagnetization coil near the localized area A of the circular magnet ring. The demagnetization coil consists of an upper coil and a lower coil, with the upper coil located above the localized area A and the lower coil positioned below it. Both coils are capable of generating a direct current pulse magnetic field (simply referred to as a “pulse magnetic field”) in the same direction. The gap D between the upper and lower coils is 2.0 mm, and the magnetic field direction is at a 90° angle to the magnetization direction of the individual magnets. The design aims for a maximum demagnetization field strength H of 5.8 T in the demagnetization region.

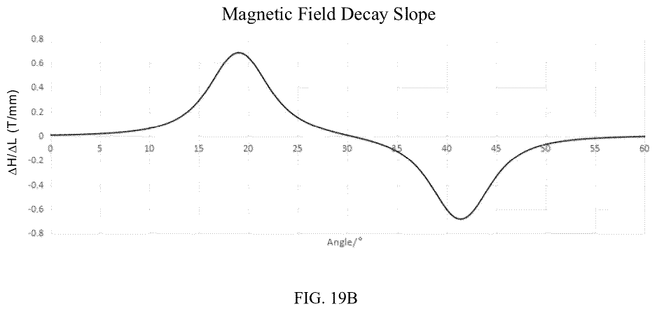

Supplying current to the demagnetization coil to generate a demagnetization field that is at a 90° angle to the magnetization direction of the localized area A of the circular ring after magnetization. FIG. 19A illustrates the simulated demagnetization magnetic field curve generated by the demagnetization coil in the localized area A of the circular ring and its adjacent regions. The horizontal axis represents the circumferential angle of the circular ring in degrees, while the vertical axis represents the demagnetization field strength produced by the coil in Tesla (T), with TR indicating the edge region of the demagnetization coil. FIG. 19B depicts the simulated curve of the decay slope of the demagnetization field (ΔH/ΔL) at different circumferential positions, with |ΔH/ΔL|ₘₐₓ=0.7 T/degree, which converts to a length unit of |ΔH/ΔL|ₘₐₓ=1.5 T/mm.

After completing the localized demagnetization, removing individual magnets A, B, and C from the magnet assembly to measure their magnetic moments M. Here, magnet A is the individual magnet that has been demagnetized, magnet B is the one adjacent to magnet A, and magnet C is the one adjacent to magnet B. Table 2 below presents the measured results in terms of the ratio M/Mₘₐₓ.

TABLE 2

| Position | M/Mₘₐₓ % |
|---|---|
| A | 18 |
| B | 95 |
| C | 100 |

Based on the results of the experiments described above, it can be seen that the magnets subjected to demagnetization using the various embodiments of the present disclosure exhibit a favorable demagnetization effect in the target localized area, while the magnetization strength in regions outside the target localized area is minimally affected by the demagnetization operation. Typically, the residual magnetic moment in the localized region of the magnet is ≤40% Mₘₐₓ, and in some embodiments≤30% Mₘₐₓ; whereas the magnetic moment in regions outside the target localized area is ≥90% Mₘₐₓ, and in some embodiments≥98% Mₘₐₓ.

In the embodiments described above, each embodiment has its unique focus; portions not elaborated upon in a specific embodiment can be referenced in the descriptions of other embodiments. The technical features of the various embodiments can be combined in any manner. For the sake of brevity, not all possible combinations of the technical features in the above embodiments are described; however, any combination of these technical features that does not present a contradiction should be considered within the scope of the present disclosure.

The above detailed description of the embodiments of the present disclosure provides specific examples to elucidate the principles and implementation methods of the present disclosure. The descriptions of the embodiments are intended solely to assist in understanding the methods and core concepts of the present disclosure. Moreover, any modifications or variations made by those skilled in the art based on the teachings of the present disclosure, in light of the specific embodiments and applications provided herein, fall within the protective scope of the present disclosure. Therefore, the content of this description should not be construed as a limitation on the present disclosure.

1. A demagnetization method for a permanent magnet, comprising:
applying a decaying alternating magnetic field to the permanent magnet, an angle between a direction of the decaying alternating magnetic field and a magnetization direction of the permanent magnet being in a range of 45° to 135°.

2. The method according to claim 1, further comprising, prior to applying the decaying alternating magnetic field:
applying a first magnetic field to the permanent magnet, an angle between a direction of the first magnetic field and the magnetization direction being in a range of 90° to 180°.

3. The method according to claim 2, wherein the angle between the direction of the first magnetic field and the magnetization direction is in a range of 120° to 180°, and the angle between the decaying alternating magnetic field and the magnetization direction is in a range of 60° to 90°.

4. The method according to claim 2, wherein the first magnetic field includes a unidirectional magnetic field having a component along the magnetization direction, and a magnitude of the component is greater than 0 and smaller than or equal to 50 KOe.

5. The method according to claim 4, wherein the magnitude of the component is greater than or equal to HcJ−p×HcJ and smaller than or equal to HcJ+p×HcJ, HcJ is a magnitude of an intrinsic coercivity of the permanent magnet, p is a preset parameter, and a value of p is greater than or equal to 0 and less than 1.

6. The method according to claim 2, wherein the first magnetic field includes a first decaying alternating magnetic field, an initial magnetic field of the first decaying alternating magnetic field has a component in the magnetization direction, a magnitude of the component is q×HcJ, HcJ is a magnitude of an intrinsic coercivity of the permanent magnet, q is a predetermined parameter, and q is greater than or equal to 0.05.

7. The method according to claim 6, wherein an oscillation decay frequency of the first decaying alternating magnetic field is within a range from 5 Hz to 1000 Hz, and an oscillation decay coefficient of the first decaying alternating magnetic field is greater than or equal to 0.20 and smaller than or equal to 0.95.

8. The method according to claim 2, further comprising, prior to applying the first magnetic field:
applying a second magnetic field to the permanent magnet, an angle between a direction of the second magnetic field and a magnetization direction of at least a portion of the permanent magnet ranging from 0° to 180°; and
removing the second magnetic field.

9. The method according to claim 2, wherein:
the first magnetic field is applied simultaneously with the decaying alternating magnetic field; or
the first magnetic field is applied and removed before applying the decaying alternating magnetic field.

10. The method according to claim 1, wherein a component of an initial magnetic field of the decaying alternating magnetic field in a direction perpendicular to the magnetization direction has a magnitude of n×HcJ, and n is greater than or equal to 0.2.

11. The method according to claim 1, wherein an oscillation decay frequency of the decaying alternating magnetic field is within a range from 10 Hz to 1000 Hz, and an oscillation decay coefficient of the decaying alternating magnetic field is within a range from 0.30 to 0.95.

12. The method according to claim 1, wherein the permanent magnet includes a single permanent magnet or a magnet assembly including a plurality of permanent magnets.

13. A demagnetization method for a localized region of a permanent magnet, comprising:
placing a demagnetization coil adjacent to the local region; and
passing an electric current through the demagnetization coil to generate a demagnetizing field forming a predetermined angle with a magnetization direction of the local region;
wherein:
the demagnetization coil includes an upper coil and a lower coil, with the upper coil positioned above the localized region and the lower coil positioned below the localized region;
magnetic field directions produced by the upper coil and the lower coil are same;
the demagnetizing field is a direct current pulse magnetic field or a decaying alternating magnetic field; and
the predetermined angle ranges from 45° to 135°.

14. The method according to claim 13, wherein the predetermined angle ranges from 82° to 98°.

15. The method according to claim 13, wherein a maximum magnetic field strength of the demagnetizing field on the localized region satisfies:
$$2.1 \times HcJ / μ r \leq H \leq 3.5 \times HcJ / μ r ,$$
where H is the magnetic field strength of the demagnetizing field, HcJ is an intrinsic coercivity of the localized region, and μr is a relative permeability of the localized region.

16. The method according to claim 13, wherein a maximum decay slope of a magnetic field strength of the demagnetizing field at an edge region of the demagnetization coil is greater than or equal to 0.5 T/mm.

17. A demagnetization device for a localized region of a permanent magnet, comprising:
an upper coil configured to be positioned above the localized region; and
a lower coil configured to be positioned below the localized region and opposite to the upper coil;
wherein magnetic field directions produced by the upper coil and the lower coil are same and form an angle ranging from 45° to 135° with a magnetization direction of the localized region.

18. The demagnetization device according to claim 17, wherein the angle between ranges from 82° to 98°.

19. The demagnetization device according to claim 17, wherein a maximum magnetic field strength of the demagnetizing field on the localized region satisfies:
$$2.1 \times HcJ / μ r \leq H \leq 3.5 \times HcJ / μ r ,$$
where H is the magnetic field strength of the demagnetizing field, HcJ is an intrinsic coercivity of the localized region, and μr is a relative permeability of the localized region.

20. The demagnetization device according to claim 17, wherein a gap D (in millimeters) between the upper coil and the lower coil satisfies:
$$D \leq 10 / μ r ,$$
where μr is a relative permeability of the local region.

21. The demagnetization device according to claim 17, further comprising:
a core rod disposed in each of the upper coil and the lower coil, a portion of the core rod remote from the local region being made of a magnetically permeable material, and a portion of the core rod adjacent to the local region being made of a non-magnetically permeable material.
